(19) United States
(12) Patent Application Publication
(10) Pub. No.: US 2025/0390088 A1
(43) Pub. Date: Dec. 25, 2025

(54) CORRELATING REMOTE CONTROL EVENTS TO INTERNAL DEVICE COMMUNICATIONS

(71) Applicant: DISH Network L.L.C., Englewood, CO (US)

(72) Inventors: Kenneth Jones, Palmer Lake, CO (US); Tyler Terteling, Denver, CO (US); Austin Montecalvo, Arvada, CO (US); Christopher Lamb, Aurora, CO (US)

(73) Assignee: DISH Network L.L.C., Englewood, CO (US)

(21) Appl. No.: 18/749,215

(22) Filed: Jun. 20, 2024

(51) Int. Cl. G05B 23/02

(52) U.S. Cl. CPC G05B 23/0216; G05B 23/027

(57) ABSTRACT

A process for testing media devices may include the step of running a test comprising a plurality of commands for execution on a remote control. A command of the test may be sent to a command tracker for logging in a first log. A robotic interface may execute the command on the remote control to transmit a signal from the remote control to a device under test. Internal communications of the device under test in response to the signal may be intercepted. The internal communications may be logged in a second log. The internal communications from the second log may be compared to an expected internal communication associated with the command from the first log.

### TECHNICAL FIELD

The present application relates generally to testing interactions between streaming devices and remote controls. Various embodiments may be used in connection with television services, telecommunication services, or other digital user services to correlate commands entered by remote control with functionality in device under test (DUT).

### BACKGROUND

Remote control devices and playback devices interact to facilitate content playback or other actions. Users press a button on the remote control and a paired playback device performs the corresponding action. In some instances, the action taken by the device can deviate from the expected action when pressing a button. The deviation could be caused in multiple parts of the system, such as by the remote control sending an incorrect signal or by the playback device taking an incorrect action in response to the correct signal. For example, an application running on the playback device may have erroneously interpreted a correct signal. In another example, firmware on a device may be incorrectly misinterpreting a correct signal. The potential for various error locations and causes can make trouble shooting difficult.

### SUMMARY

Various embodiments relate to processes, computing systems, devices, and other aspects of testing media devices. An example process may include the step of running a test comprising a plurality of commands for execution on a remote control. A command of the test may be sent to a command tracker for logging in a first log. A robotic interface may execute the command on the remote control to transmit a signal from the remote control to a device under test. Internal communications of the device under test in response to the signal may be intercepted. The internal communications may be logged in a second log. The internal communications from the second log may be compared to an expected internal communication associated with the command from the first log.

In various embodiments, the test system may throw an error in response to the internal communications excluding the expected internal communication. The test system may throw an error in response to detecting a timing anomaly in the internal communications. The example process may include logging a successful command in a third log in response to detecting the expected internal communication in the internal communications from the second log. The process may include logging a successful command in a third log in response to detecting the expected internal communication in the internal communications within a predetermined period of a timestamp of the command in the first log. Executing the command can include pressing a button on the remote control and playing a voice component from a speaker. The robotic interface may press the button and play the voice component in response to a tracker logging the command in a command log. A tap that is electronically coupled to an internal bus of the device under test may be monitored. The tap may carry a signal that includes the internal communications.

An example test system may include a console that transmits a command and a robotic interface that executes the command from the console on a remote control. The remote control generates a signal in response to the command. A device under test may receive the signal from the remote control. The device under test can include an internal bus that carries internal communications in response to the signal. A tap may be configured to intercept the internal communications on the internal bus. A monitor may be in electronic communication with the tap and configured to log the internal communications in a communication log. The console may be configured to detect an expected communication associated with the command in the communication log in response to transmitting the command.

In various embodiments, a tracker may be configured to receive the command from the console and log the command in a command log. An automatic remote tester may be in communication with the console. The automatic remote tester may include the monitor, the tracker, and the robotic interface. The monitor and the tracker may be in electronic communication with the console. The console may be configured to compare expected commands associated with the command log with logged communications from the communication log.

Another example process may include the step of sending a command for a remote control to a robotic interface. The command may be associated with an expected internal communication in a device under test. The robotic interface may execute the command on the remote control to transmit a signal. An internal communication of the device under test may be intercepted in response to the signal. The internal communication of the device under test can be compared with the expected internal communication to generate a test result.

In various embodiments, the test result may be generated at least in part by throwing an error in response to the expected internal communication missing from the intercepted internal communication. Generating the test result can include throwing an error in response to a discrepancy between a timestamp of the intercepted internal communication and a timestamp of the command associated with the expected internal communication. A successful command may be logged in response to detecting the expected internal communication in the internal communication. Generating the test result may include logging a successful command in response to detecting a timestamp of the expected internal communication within a predetermined period of a timestamp of the intercepted internal communication. In some examples, executing the command includes pressing a button on the remote control and playing a voice component from a speaker. Intercepting the internal communication may include monitoring a tap electronically coupled to an internal bus of the device under test. A signal on the tap can include the internal communication.

Other devices, systems, and automated processes may be formulated in addition to those described in this brief description.

### DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the illustrations.

FIG. 1 illustrates an example test system for triggering remote control commands and monitoring internal device communications, in accordance with various embodiments;

FIG. 2 illustrates an example DUT suitable for testing remote control commands and resulting internal device communications, in accordance with various embodiments;

FIG. 3 illustrates an example robotic interface for actuating controls of a remote control, in accordance with various embodiments; and

FIG. 4 illustrates an example process for correlating remote control commands with internal device communications, in accordance with various embodiments.

### DETAILED DESCRIPTION

The following detailed description is intended to provide several examples that will illustrate the broader concepts set forth herein, but it is not intended to limit the invention or applications of the invention. Furthermore, there is no intention to be bound by any theory presented in the preceding background or the following detailed description.

Systems, methods, and devices (collectively, the “System”) of the present disclosure can compare the button presses and non-user input events on a radio frequency (RF) remote to the data received by a RF transceiver on a set-top box (STB) prior to input management software processing. By logging the response of the RF transceiver during transmission to the DUT (e.g., prior to processing), the System can verify the received information was correct, the input management software translated the information correctly, the remote firmware (FW) is correctly performing, and the set-top box RF transceiver is fully functional. Systems of the present disclosure may also be used to characterize and quantify the effects of a crowded RF environment, such as a mix of paired and unpaired remotes pinging and performing actions like button presses, FW downloads, pings, and other traffic.

The System can be used in real time to associate remote button presses or non-user input events (FW downloads, periodic pings, etc.) with RF transceiver responses prior to SoC processing. This allows for low level troubleshooting and characterization of the RF transceiver FW and digital communication interfaces. The System can examine the RF transceiver response divorced from the input management software. The System may include a robotic remote testing system. While we use RF systems as an example, the System can also operate using IR, BT, UHF, and other data transmission protocols. The System is platform agnostic and can be applied to any RF communication integrated circuits (ICs) used for remotes since the communication protocols are specified and bounded.

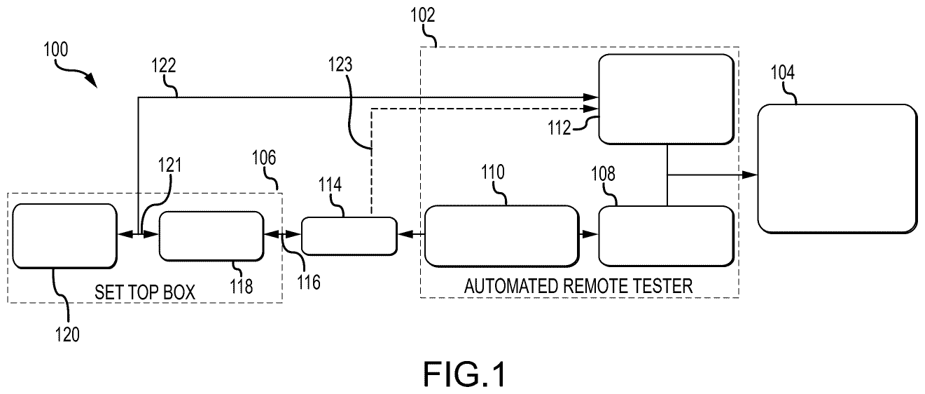

Referring now to FIG. 1, an example test system 100 is shown, according to various embodiments. Test system 100 can comprise an automated remote tester 102 in communication with console 104 and device under test (DUT) 106. Console 104 can comprise an input device. Console 104 can be, for example, a computer, server, laptop, smartphone, smart device, or other computing device capable of electronic communication with automated remote tester 102. DUT 106 can comprise a set-top box, DVR device, streaming device, place-shifting device, smart TV, playback device, computing device, computer, smartphone, laptop, server, or other media devices capable of receiving commands from remote control 114.

Various electronic devices and computing devices described herein may comprise a processor in communication with a non-transitory computer-readable memory or other media. The memory may store instructions thereon that, when executed by the processor, cause the processor to perform operations to support the functionality of test system 100 described herein. For example, automated remote tester 102, console 104, and DUT 106 can comprise individual computing devices configured with processors, memory, permanent storage, network interfaces, and other computing components. In some examples, console 104 or some components of automated remote tester 102 can run in virtualized systems on cloud servers.

In various embodiments, automated remote tester 102 may include monitor 112 and command tracker 108. Command tracker 108 can receive commands from console 104. Command tracker 108 can also record commands received from console 104 or sent to robotic interface 110. Commands can be entered by script or command line in some embodiments. Commands or combinations of commands can include durations of button presses, sequences of button presses, repeated button presses, or other variations that can mimic inputs from different users or common input errors. In some embodiments, a graphical interface on console 104 can enable users to select, configure, or otherwise generate commands on console 104 for transmission to command tracker 108. Although command tracker 108 and monitor 112 are depicted as part of automated remote tester 102, these functional units can operate as stand-alone devices, as applications on standalone devices, as cloud applications, as applications on console 104, or any other suitable hardware and software combination capable of carrying out the functions of command tracker 108 or monitor 112.

In various embodiments, command tracker 108 can log the commands or buttons entered in remote control 114 by robotic interface 110. The logged commands can later be compared to communication traffic captured in DUT 106. Logged commands can be stored along with a timestamp. The timestamp can document the time a command was sent to or received by the robotic interface 110. The timestamp can document the time a command was written to the log file. Command tracker can log commands and timestamps using a flat file, CSV file, JSON file, html file, relational database, unstructured data store, or using other data storage and retrieval techniques.

In various embodiments, robotic interface 110 can comprise an arm for pressing buttons. For example, robotic interface 110 can be configured to press buttons on remote control 114 in response to commands received from command tracker 108. Robotic interface 110 may be programmed to depress buttons on remote control 114 having various button layouts in response to commands. Commands can thus correspond to buttons on the remote control.

In some examples, remote control 114 can include a voice input button and microphone, and robotic interface 110 can include a speaker to reproduce a voice component of commands for testing. Commands including a voice component can include an audio file for use as the voice component, text for use as the voice component, or a voice command from a tester for use as the voice component. Robotic interface 110 can convert text to speech in some embodiments for audible playback through a speaker in response to depressing a voice command button on remote control 114. The voice component of a command can be played by a speaker of robotic interface 110 and captured by a microphone of remote control 114 under test.

Remote control 114 can be equipment configured to interact with DUT 106, in accordance with various embodiments. Remote control 114 can be paired with or otherwise coded to DUT 106. DUT 106 thus knows to take action in response to commands received from remote control 114 in automated test system 100. Remote control 114 can be original equipment sold or shipped with DUT 106. Remote control 114 can be a universal remote control or a remote-control application running on a smartphone or computing device, for example. Other types of remote controls 114 capable of receiving input from robotic interface 110 may equivalently be compatible with automated test system 100.

In the example of FIG. 1, remote control 114 transmits RF signal 116 in response to input from robotic interface 110 of automated remote tester 102. While radio frequency is used in the example of FIG. 1, other electromagnetic frequencies can be used in automated test system 100. For example, remote control 114 and transceiver 118 communicating using microwaves, infrared, visible light, ultraviolet, x-rays, gamma rays, or other electromagnetic wavelengths could be tested in automated test system 100. Continuing the example of FIG. 1, remote control 114 transmits a signal to transceiver 118 of DUT 106. The transmitted signal is emitted in response to input (e.g., button press or voice input) from robotic interface 110.

In various embodiments, transceiver 118 may receive the signal from remote control 114 through an antenna. The signal received by transceiver 118 can be electronically communicated to processor 120 via internal bus 121. Processor 120 can receive the command and take appropriate steps to implement the command based on firmware or software running on DUT 106. Tap 122 may comprise wired or wireless communication channels that detect communication on internal bus 121. In some examples, an RF monitor 123 can capture the raw RF signal generated by remote control 114 in response to button actuation. The raw RF signal can be compared to the expected RF signal from executed button presses as a secondary validation for the log of commands sent from remote control 114 during testing. Monitor 112 reads communications on internal bus 121 and logs the communications. The communications logged by monitor 112 can comprise internal commands for comparison to remote commands logged by command tracker 108.

In various embodiments, monitor 112 can track RF packets in communication from transceiver 118 to processor 120. Monitor 112 can capture all traffic present on the line between RF transceiver and processor 120. Monitor 112 can comprise a packet sniffer, a logic analyzer, an oscilloscope, or other hardware suitable for detecting signal-level traffic, decoding packets, or identifying communication contents. Monitor 112 can detect and decode protocols such as serial peripheral interface (SPI), inter-integrated circuit (12C), serial, or other protocols used in communication between transceiver 118 and processor 120 internal to DUT 106. In some examples, internal communications are formatted as I2C communications written to internal bus 121 by transceiver 118.

In various embodiments, communications captured and logged by monitor 112 can include timestamps for the commands, communications, decoded protocols, or other communication on transceiver 118. Communications can be written for later retrieval and review. For example, communications captured by monitor 112 can be logged using the techniques similar to those used by command tracker 108 in logging commands. Monitor 112 can log decoded communications using a flat file, CSV file, JSON file, html file, relational database, unstructured data store, or using other data storage and retrieval techniques.

In various embodiments, the logs captured by monitor 112 can be displayed visually on a monitor or other visual display device. The expected communications written by command tracker 108 can also be displayed on a monitor or visual display device. In some examples, the RF commands in the command log can be translated to internal communications (e.g., 12C commands) expected on internal bus 121. The expected internal communications can be displayed side by side with the detected internal communications to identify unexpected behavior in the firmware or software running on DUT. In some examples, automatic remediation can be applied to the software or firmware running on DUT. Automatic remediation can comprise system 100 automatically programming a test version of firmware or software configured to trigger the expected internal communications in response to the logged commands from remote control 114. The test can be re- run against the test software or firmware to determine whether the automatic remediation was successful. Successful revisions in automated remediation can be flagged for review by engineers for accuracy and efficacy prior to deployment or commitment into a software repository.

The logged communications from monitor 112 and logged commands from command tracker 108 may be accessed using console 104. In some examples, console 104 can run a graphical user interface (GUI) that displays logged communications from monitor beside logged commands from command tracker 108. A GUI may enable engineers to compare sent commands to detected communications using timestamps to associate the two.

In some examples, console 104 may run automated test software or scripts that compare logs from command tracker 108 and monitor 112 to identify button presses of remote control 114 and responsive activity in DUT 106. Console 104 can indicate a test has passed if expected communication activity responsive to a command or button press of remote control 114 is detected on internal bus 121. Console 104 can indicate a test has failed if expected communication activity responsive to a command or button press of remote control 114 is not detected on internal bus 121. Console 104 can also indicate success or failure in response to timing being within or outside of expected tolerances, respectively. In some examples, console 104 can throw errors or log passes and failures. Logged passes and failures can include the logged command of command tracker 108 and the corresponding logged communication of monitor 112 detected on internal bus 121.

A brief delay may pass between the timestamp in the command log of command tracker 108 and the timestamp of corresponding communications logged by monitor 112 in various embodiments. The delay or lag can be approximately 1 millisecond (ms), approximately 5 ms, approximately 10 ms, approximately 20 ms, or any other duration suitable to allow remote control 114 to transmit a signal and monitor 112 to detect responsive activity on internal bus 121.

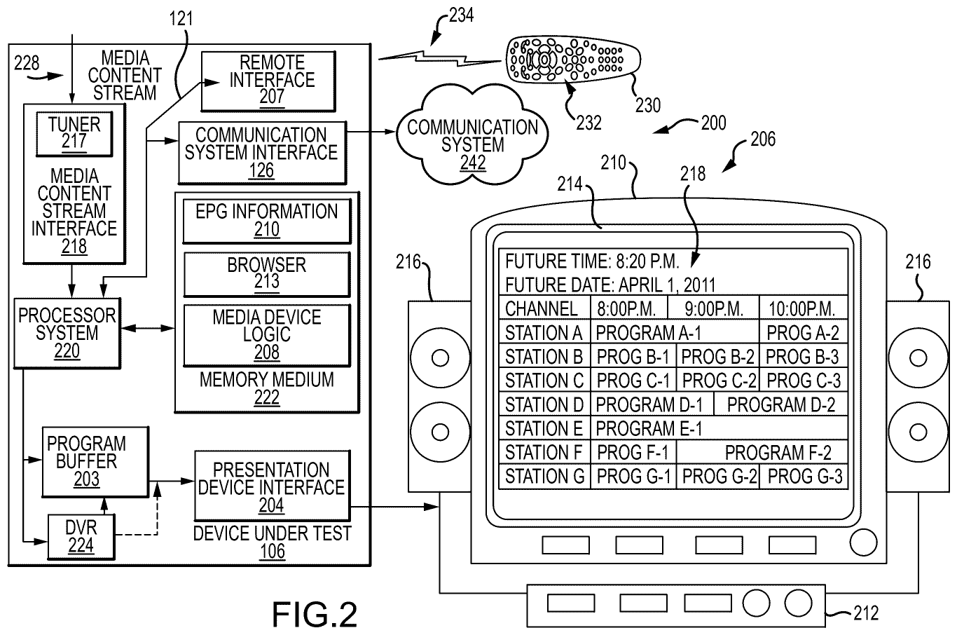

Referring now to FIG. 2, an example DUT 106 is shown in playback system 200, in accordance with various embodiments. In the example of FIG. 2, DUT 106 comprises an example set-top box communicatively coupled to a media presentation system 206 in the field, the system including a visual display device 210. A visual display device 210 can include a television, and an audio presentation device 212, such as a surround sound receiver controlling an audio reproduction device. The video portion of a presenting media can be presented to a user on a display 214 of the visual display device 210. The audio portion of a presenting media content event can be reproduced as audible sounds by one or more speakers 216 of the audio presentation device. Other types of output devices may also be coupled to the DUT 106, including those providing any sort of stimuli sensible by a human being, such as temperature, vibration and the like. In some embodiments, the DUT 106 and one or more of the components of the media presentation system 206 may be integrated into a single electronic device.

The non-limiting exemplary DUT 106 comprises a media content stream interface 218, a processor system 220, a memory medium 222, a digital video recorder (DVR) 224, and n communication system interface 126. Other DUT 106 may include some, or may omit some, of the above-described media processing components. Further, additional components of the DUT 106 not described herein may be included in alternative embodiments.

In a satellite broadcast system, a media content broadcast provider provides media content that is received in one or more broadcasting multiple media content streams 228 multiplexed together in one or more transport channels. The transport channels with the media content streams 228 are communicated to the DUT 106 from a media system sourced from a remote head end facility operated by the media content broadcast provider. The DUT 106 is configured to receive one or more broadcast satellite signals detected by an antenna. Non-limiting examples of other media systems that broadcast a media content stream 228 include a cable system, a radio frequency (RF) communication system, and the Internet. Here, broadcasting refers to the process of communicating one or more media content streams 228 over a broadcast communication system to a plurality of media devices that are communicatively coupled to the broadcast communication system. Often, the media content is broadcast to hundreds of, or even thousands of, media devices that concurrently receive the broadcasting media content stream(s) 228.

Media content streams 228 are received by the media content stream interface 218. The media content streams 228 are processed in accordance with instructions received from the processor system 220. The processor system 220, based upon a request for a particular broadcasting media content event specified by a user, parses out media content associated with the specified media content event. The media content event is then assembled into a stream of video or audio information that is streamed out to components of the media presentation system 206, such as the visual display device 210 or the audio presentation device 212. Alternatively, or additionally, the parsed-out media content may be saved into the DVR 224 for later presentation. The DVR 224 may be directly provided in, locally connected to, or remotely connected to, the DUT 106. In alternative embodiments, the media content streams 228 may be stored for later decompression, processing and/or decryption.

The exemplary DUT 106 is configured to receive commands from a user via a remote control 230. The remote control 230 includes one or more controllers 232 disposed on the surface of the remote control 230. The user, by actuating one or more of the controllers 232, causes the remote control 230 to generate and transmit commands, via a wireless signal 234, to the DUT 106. Preferably, each individual one of the controllers 232 has a specific predefined function that causes a specific operation by the DUT 106 and/or by components of the media presentation system 206. The commands communicated from the remote control 230 then control the DUT 106 and/or control components of the media presentation system 206. The wireless signal 234 may be an infrared (IR) signal or a radio frequency (RF) signal that is detectable by the DUT 106.

A remote control can include controller 232 (e.g., a button or touch interface) configured to enable voice commands through the remote control. In some embodiments, the controller 232 has a recognizable color, symbol or other marking that the user intuitively understands or remembers to be associated with voice commands. In an example embodiment, actuation of the controller 232 initiates a microphone built into remote control 230. Remote control 230 may parse voice commands and transmit corresponding signals to DUT 106 using wireless signal 234.

A media content event may be stored on a memory medium that is communicatively couplable to DUT 106. An example memory medium can comprise a DVD, though the media content event may be stored on any suitable memory medium. Another non-limiting example of a memory medium is a flash drive or uniform serial bus (USB) drive. The external device, such as a DVD player, can be communicatively coupled to the DUT 106. In operation, the media content event stored on the memory medium is accessed by the external device and is then streamed out as a media content stream to the DUT 106. In some embodiments, the external device may be integrated into the DUT 106 as an internal component.

A media content event may also be available to the DUT 106 from a remote site (not shown). The DUT 106 communicatively couples to the remote site via a suitable communication system 242. The communication system interface 126 is configured to communicatively couple the media device to the communication system using a suitable wireless or wire-based connector and/or link. A non-limiting example of an external site is a VOD system operated by a VOD content provider. Here, when the user requests a particular indicated media content event of interest, the DUT 106 communicates a request for that indicated media content event the remote site. The remote site then streams the requested media content event, via the communication system 242, to the DUT 106.

A non-limiting example DUT 106 comprises a media content stream interface 218, a processor system 220, a memory medium 222, a program buffer 203, a digital video recorder (DVR) 224, a presentation device interface 204, a remote interface 207, and the communication system interface 126. The memory medium 222 comprises portions for storing the media device logic 208, the electronic program guide (EPG) information, and a browser 213. In some embodiments, media device logic 208, browser 213, and the other logic may be integrated together, or may be integrated with other logic. In various embodiments, some or all of these memory and other data manipulation functions may be provided by using a remote server or other electronic devices suitably connected via the Internet or otherwise to a client device. Other media devices may include some, or may omit some, of the above-described media processing components. Further, additional components not described herein may be included in alternative embodiments.

In a satellite broadcast system, a broadcast content provider provides media content that is received in one or more multiple media content streams 228 multiplexed together in one or more transport channels. The transport channels with the media content streams 228 are communicated to the DUT 106 from a media system sourced from a media content broadcast facility operated by the broadcast content provider. The DUT 106 is configured to receive broadcast satellite signals detected by the receiver antenna or tuner 217. Non-limiting examples of other media systems suitable for broadcasting media content stream 228 may include a cable system, a radio frequency (RF) communication system, or the Internet.

The one or more media content streams 228 are received by the media content stream interface 218. One or more tuners 217 in the media content stream interface 218 selectively tune to one of the media content streams 228 in accordance with instructions received from the processor system 220. The processor system 220, executing the media device logic 208 and based upon a request for a media content event of interest specified by a user, parses out media content associated with the media content event of interest. The media content event of interest is then assembled into a stream of video or audio information, which may be stored by the program buffer 203 such that the media content can be streamed out to components of the media presentation system 206. Alternatively or additionally, the parsed-out media content may be saved into the DVR 224 for later presentation. The DVR 224 may be directly provided in, locally connected to, or remotely connected to, the DUT 106. In alternative embodiments, the media content streams 228 may be stored for later decompression, processing and/or decryption.

In this simplified embodiment, the presentation device interface 204 is illustrated as coupled to the media presentation system 206 that includes the visual display device 210 and the audio presentation device 212. Other types of output devices may also be coupled to the DUT 106, including those providing any sort of stimuli sensible by a human being, such as temperature, vibration and the like. The video portion of the streamed media content can be displayed on the display 214 and the audio portion of the streamed media content is reproduced as sounds by the speakers 216. In the test environment of FIG. 1, DUT 106 may be disconnected from visual display device 210.

From time to time, information populating the EPG information portion of the memory medium 222 is communicated to the DUT 106, via the media content stream 228 or via another suitable media. The EPG information stores the information pertaining to the scheduled programming of broadcasting indicated media content events. The information may include, but is not limited to, a scheduled presentation start and/or end time, a channel that the media content event is associated with, and descriptive information for each media content event. The media content event's descriptive information may include the title of the media content event, names of performers or actors, date of creation, and a summary describing the nature of the media content event. Any suitable information may be included in the media content event's supplemental information. Upon receipt of a command from the user requesting presentation of an EPG display, the information in the EPG information is retrieved, formatted, and is then presented on the display 214 as an EPG.

The processes performed by the DUT 106 relating to the processing of the received media content stream 228 and communication of a presentable media content event to the components of the media presentation system 206 are generally implemented by the processor system 220 while executing the media device logic 208. Thus, the DUT 106 may perform a variety of functions related to the processing and presentation of one or more media content events received in the media content stream 228.

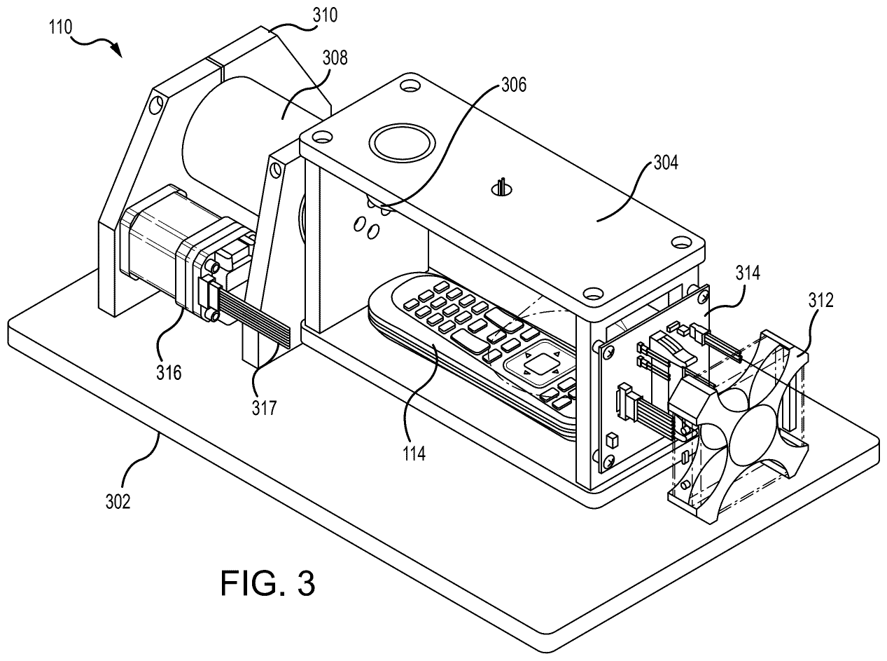

In the example of FIG. 3, the user may actuate one or more controllers 232 of the remote control 230 to cause the DUT 106 to perform a function relative to the selected media content event or channel of interest. Remote control 230 sends a wireless signal 234 in response to actuation of the controllers 232. The wireless signal is received at remote interface 207 (e.g., an RF transceiver). The transceiver can read wireless signal 234 and write a corresponding signal on internal bus 121. Processor system 220 reads the internal bus 121 and processes the signal carried on internal bus 121 from the transceiver, the internal signal comprising internal commands for DUT 106. The internal commands on internal bus 121 can be captured using the example system of FIG. 1 and compared to the controllers 232 actuated on remote control 230.

With reference to FIG. 3, an example robotic interface 110 is shown, in accordance with various embodiments. Robotic interface 110 may comprise base 302, which is depicted as flat in the example of FIG. 3. Support members 310 may extend from base 302. Support members 310 may retain cylindrical body 308 over base 302. Cylindrical body 308 may be coupled to remote housing 304. Electronics 316 may be coupled to support members 310.

In the example of FIG. 3, remote housing 304 has a rectangular-cuboid geometry. Remote 114 may be coupled to an inner surface of remote housing 304. In some embodiments, wiring harness 317 is installed on remote control 114 that makes a connection from each column and row of the push button switch matrix to a connector mounted on the bottom of the remote. In some examples, a ribbon cable may connect to motherboard 314 and may plug into the wiring harness connector on the bottom of remote control 114. Motherboard 314 may include an analog crosspoint switch that can electrically or programmatically connect each row to each column of the switch matrix. The firmware for robotic interface 110 can programmatically close the connections using the crosspoint switch or other switching mechanism to activate a button press on remote control 114. In some embodiments, a robotic arm can be programmed to depress buttons. Programs for remote controls can be stored in a library for retrieval when retesting a remote control 114 or DUT 106.

In some examples, robotic interface 110 can include power leads that are connectable to the power leads of remote control 114. Remote control 114 may thus be tested without batteries, and the leads can provide controllable currents or voltages from a programmable power supply. Robotic interface 110 can simulate varying battery conditions and power cycling by controlling the power supplied to remote control 114 during testing.

In various embodiments, robotic interface 110 can include a field of view of a color camera (e.g., an optical sensor). The lens of the camera can give an actual field of view that covers the entire length of remote control 114. The camera can be used to test or observe the backlight LEDs and the mode LEDs on remote control 114 during testing. Robotic interface 110 may include speaker 306. Speaker 306 may be a wireless, battery powered speaker in some embodiments. Speaker 306 can be activated to test the voice command and control of remote control 114.

Robotic interface 110 may include data acquisition module 312. Data acquisition module 312 may stimulate, monitor, and power remote control 114 during testing. The robotic interface 110 may stimulate and monitor all input and output aspects of remote control 114. Examples of remote operations suitable for simulation or monitoring can include button presses, combination presses, single or multiple presses, and varied duration presses. Button presses can be programmed and simulated using a crosspoint switch and software.

In various embodiments, robotic interface 110 can test ambient lighting that is programmable using an enclosure surrounding remote housing 304, which can make ambient conditions dark. An LED light source integrated into robotic interface 110 can control the light levels around remote control 114 during testing. Robotic interface 110 can test and monitor audio input. Audio input can be supplied through speaker 306 and can include sounds, voice, different languages, different audio levels, test tones, and or any other sound that can be put into an mp3 file.

In various embodiments, remote interface 110 can test audio output from capable remote controls 114. Audio output (e.g., a remote buzzer) can be monitored with a microphone attached to the camera in housing 304. Tone, duration, or amplitude can be monitored and tested. Robotic interface 110 can further test and monitor the RF environment in some examples. Robotic interface 110 can be disposed within an existing RF/EMI enclosure, in which the RF environment can be controlled by inhibiting external interference.

Various embodiments of robotic interface 110 can monitor and test ambient temperature. Ambient temperature can be controlled in response to robotic interface 110 being installed into an RF enclosure or other enclosure. A camera in housing 304 can be used to monitor the coverage, intensity, and presence of backlight emanating from remote control 114 under test. The camera can similarly monitor and test the LED response.

In various embodiments, housing 304 of robotic interface 110 can be rotatable about an axis defined through cylindrical body 308. The rotating housing or cradle can be used to control the orientation of the remote during testing. In some examples, the backlight of remote control 114 can respond differently to remote control 114 being face down. Housing 304 can also be rotated to activate the motion sensing features of remote control 114. In some examples, remote control may include a backlight responsive to motion or commands sent from the remote control in response to motion (e.g., wand-style remotes). Robotic interface 110 can also test and monitor power cycling and simulation of different battery discharge conditions using a programmable power supply electrically connected to remote control 114.

Robotic interface 110 can be integrated into automated remote tester 102 of FIG. 1 to programmatically test remote control 114 and DUT 106. Commands can be simulated in remote control 114 using the crosspoint switch that can electrically or programmatically connect each row to each column of a switch matrix in remote control 114. The commands triggered programmatically on remote control 114 can be received at transceiver 118. Transceiver 118 can transform the RF signal from remote control 114 to internal communications suitable for processing at processor 120. The commands executed on remote control 114 can be compared to internal communications captured on tap 122 into internal bus 121.

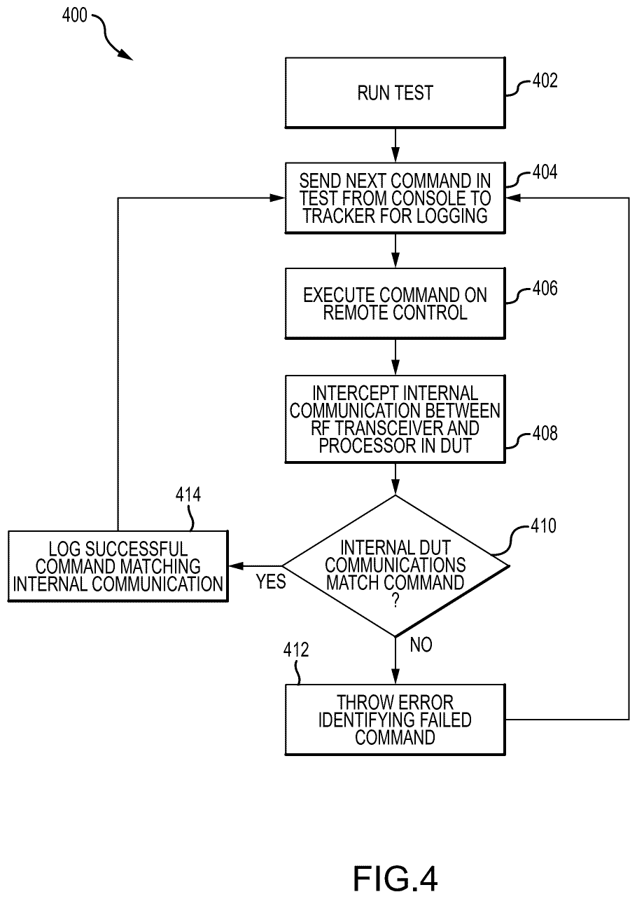

With reference to FIG. 4 and continuing reference to FIG. 1, an example process 400 is shown for testing DUT 106 using automated test system 100, in accordance with various embodiments. Console 104 can run a test (Block 402). Console 104 can run a test by issuing a single command, by issuing a series of commands, by running a script of commands, or by otherwise causing robotic interface 110 to press a button or issue a voice command using remote control 114.

Console 104 may send the next command in the test to command tracker 108 for logging (Block 404). Tracker 108 may log the command as described above. In some examples, command tracker 108 may log commands in response to sending the commands to robotic interface 110. In some examples, command tracker 108 may log commands in response to receiving a confirmation from robotic interface 110 that the command is schedule for execution, is being executed, or has been executed on remote control 114. The logs of command tracker 108 may include timestamped entries for each command sent to robotic interface 110.

In various embodiments, command tracker 108 (or console 104) may instruct robotics to execute the next command on remote control 114. Robotic interface 110 executes the command on remote control 114 (Block 406). Robotic interface 110 can press buttons on remote control 114 that correspond to commands from console 104 or command tracker 108. On remote controls that include a voice interaction button, robotic interface 110 can depress the voice interaction button and playback a voice command. The voice commands can be prerecorded or generated live. The voice commands can comprise synthetic voice commands, prerecorded voice commands, voice commands stored in audio files, or live voice commands from an engineer, for example.

In various embodiments, the wireless signal sent from remote control 114 in response to interaction with robotic interface 110 is captured at transceiver 118. Transceiver 118 can translate the wireless signal from remote control command into internal commands for DUT 106. Communications between transceiver 118 and processor 120 of DUT may be facilitated by internal bus 121. Tap 122 may be used to monitor internal bus 121.

In various embodiments, monitor 112 intercepts internal communication between transceiver 118 and processor 120 in DUT 106 (Block 408). Monitor 112 uses tap 122 to capture communication between transceiver 118 and processor 120 on internal bus 121. Monitor 112 detects line-level communications and converts the analog or digital signal to readable communications. For example, monitor 112 can detect activity on internal bus 121 and translate the activity to readable communications using the 12E protocol. Monitor 112 can thus identify packets and packet contents according to known protocols. The translated communications are timestamped and logged by monitor 112 and can be compared to commands logged by command tracker 108.

Test system 100 may compare the logs of monitor 112 with the logs of tracker 108 (Block 410). The comparison can include identifying expected communications associated with commands logged by tracker 108. The expected communications can be in the form of the internal protocol used by transceiver 118 and processor 120 of DUT 106 for internal communication. Console 104 can look for the expected communications in communication logs of monitor 112. Console 104 may identify a timestamp of a command in logs of command tracker 108 and search the logs of monitor 112 for expected communications within a predetermined period of the timestamp. For example, console 104 may search for expected communications occurring within a period of approximately 10 ms, approximately 20 ms, approximately 30 ms, or approximately 40 ms after the corresponding command.

In various embodiments, console 104 may log a successful command in response to detecting the expected communications in the log of monitor 112 (Block 414). Console 104 may throw an error identifying the failed command (Block 412). The error can also include the expected communications, excerpts from the log of monitor 112, timestamp of the command, or other information suitable to aid in analysis of the error. Console 104 may send the next command in the test to command tracker 108 for execution by robotic interface 110 (Block 404) in response to logging a successful test or an error.

The System of the present disclosure tests a DUT 106 for packetization in response to remote control commands. A known remote control signal may be sent to the DUT, and the known signal can be expected to trigger known internal communications in the DUT. The internal communications are monitored, for example, using a tap to listen to an internal communication bus. The internal communications detected on the internal communications bus can be compared to the expected communications associated with the known command to detect errors in packetization between a transceiver and processor both internal to the DUT.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions.

The scope of the invention is accordingly to be limited by nothing other than the appended claims, in which reference to an element in the singular is not intended to mean “one and only one” unless explicitly so stated, but rather “one or more.” Moreover, where a phrase similar to “A, B, or C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment. For example, A and B, A and C, B and C, or A and B and C.

References to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or device that comprises a list of elements does not include only those elements but may include other elements not expressly listed or inherent to such process, method, article, or device.

The term “exemplary” is used herein to represent one example, instance, or illustration that may have any number of alternates. Any implementation described herein as “exemplary” should not necessarily be construed as preferred or advantageous over other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. A process comprising:
running a test comprising a plurality of commands for execution on a remote control;
sending a command of the test to a command tracker for logging in a first log;
executing, by a robotic interface, the command on the remote control to transmit a signal from the remote control to a device under test;
intercepting internal communications of the device under test in response to the signal, wherein the internal communications are logged in a second log; and
comparing the internal communications from the second log to an expected internal communication associated with the command from the first log.

2. The process of claim 1, further comprising throwing an error in response to the internal communications excluding the expected internal communication.

3. The process of claim 1, further comprising throwing an error in response to detecting a timing anomaly in the internal communications.

4. The process of claim 1, further comprising logging a successful command in a third log in response to detecting the expected internal communication in the internal communications from the second log.

5. The process of claim 1, further comprising logging a successful command in a third log in response to detecting the expected internal communication in the internal communications within a predetermined period of a timestamp of the command in the first log.

6. The process of claim 1, wherein executing the command comprises:
pressing a button on the remote control; and
playing a voice component from a speaker.

7. The process of claim 6, wherein the robotic interface presses the button and plays the voice component in response to a tracker logging the command in a command log.

8. The process of claim 1, wherein intercepting the internal communications further comprises monitoring a tap electronically coupled to an internal bus of the device under test, wherein the tap carries a signal that includes the internal communications.

9. A test system comprising:
a console that transmits a command;
a robotic interface that executes the command from the console on a remote control, wherein the remote control generates a signal in response to the command;
a device under test configured to receive the signal from the remote control, the device under test comprising an internal bus that carries internal communications in response to the signal;
a tap configured to intercept the internal communications on the internal bus; and
a monitor in electronic communication with the tap and configured to log the internal communications in a communication log, wherein the console is configured to detect an expected communication associated with the command in the communication log in response to transmitting the command.

10. The test system of claim 9, further comprising a tracker configured to receive the command from the console and log the command in a command log.

11. The test system of claim 10, further comprising an automatic remote tester in communication with the console, the automatic remote tester comprising the monitor, the tracker, and the robotic interface.

12. The test system of claim 10, wherein the monitor and the tracker are in electronic communication with the console.

13. The test system of claim 12, wherein the console is configured to compare expected commands associated with the command log with logged communications from the communication log.

14. A process comprising:
sending a command for a remote control to a robotic interface, wherein the command associated with an expected internal communication in a device under test;
executing, by the robotic interface, the command on the remote control to transmit a signal;
intercepting an internal communication of the device under test in response to the signal; and
comparing the internal communication of the device under test with the expected internal communication to generate a test result.

15. The process of claim 14, wherein generating the test result comprises throwing an error in response to the expected internal communication missing from the intercepted internal communication.

16. The process of claim 14, wherein generating the test result comprises throwing an error in response to a discrepancy between a timestamp of the intercepted internal communication and a timestamp of the command associated with the expected internal communication.

17. The process of claim 14, further comprising logging a successful command in response to detecting the expected internal communication in the internal communication.

18. The process of claim 14, wherein generating the test result comprises logging a successful command in response to detecting a timestamp of the expected internal communication within a predetermined period of a timestamp of the intercepted internal communication.

19. The process of claim 14, wherein executing the command comprises:
pressing a button on the remote control; and
playing a voice component from a speaker.

20. The process of claim 14, wherein intercepting the internal communication further comprises monitoring a tap electronically coupled to an internal bus of the device under test, wherein a signal on the tap includes the internal communication.
